(19) United States
(12) Patent Application Publication
(10) Pub. No.: US 2020/0192824 A1
(43) Pub. Date: Jun. 18, 2020

(54) SECURITY MEMORY DEVICE AND OPERATION METHOD THEREOF

(71) Applicant: MACRONIX INTERNATIONAL CO., LTD., Hsinchu (TW)

(72) Inventors: Yu-Chen WANG, Kaohsiung City (TW); Chia-Jung CHEN, Zhubei City (TW); Chin-Hung CHANG, Tainan City (TW); Ken-Hui CHEN, Hsinchu City (TW)

(21) Appl. No.: 16/217,081

(22) Filed: Dec. 12, 2018

(51) Int. Cl. G06F 12/14; G06F 21/78; G06F 21/44

(52) U.S. Cl. CPC G06F 12/1458; G06F 12/1408; G06F 2212/1052; G06F 21/44; G06F 21/78

(57) ABSTRACT

A security memory device coupled to a host includes: a normal region for storing normal data; a security region for storing security data; and a memory controller, coupled to the normal region and to the security region. In response to a first command which is issued from the host and indicates the security memory device to enter a security field, the memory controller allows the host to access the security region. In the security field, the memory controller performs at least one security command set on the security region. In response to a second command which is issued from the host and indicates the security memory device to exit the security field, the memory controller prohibits the host from accessing the security region.

### TECHNICAL FIELD

The disclosure relates in general to a security memory device and an operation method thereof.

### BACKGROUND

A number of new applications for electronic devices have emerged during the last several decades. Many of these include need for security of information stored in the electronic devices. At the same time, a high degree of data security is important.

Protecting memories from accidental or intentional corruption, as well as unauthorized copying or cloning is essential. Thus, there is a need to provide flash memory security solutions for meeting this growing challenge.

### SUMMARY

The disclosure is directed to a security memory device and an operation method thereof. In response to an ENSF (enter security field) command from a host, the security memory device enters the security field and thus the host is allowed to access a security region of the security memory device. In response to an EXSF (exit security field) command from the host, the security memory device exits the security field and then the host is prohibited from accessing the security region. Thus, security protection of the security memory device is implemented.

According to one embodiment, a security memory device is provided. The security memory device coupled to a host includes: a normal region for storing normal data; a security region for storing security data; and a memory controller, coupled to the normal region and to the security region. In response to a first command which is issued from the host and indicates the security memory device to enter a security field, the memory controller allows the host to access the security region. In the security field, the memory controller performs at least one security command set on the security region. In response to a second command which is issued from the host and indicates the security memory device to exit the security field, the memory controller prohibits the host from accessing the security region.

According to another embodiment, provided is an operation method for a security memory device coupled to a host. The operation method includes: in response to a first command which is issued from the host and indicates the security memory device to enter a security field, allowing the host to access a security region of the security memory device by a memory controller of the security memory device; in the security field, performing at least one security command set on the security region by the memory controller; and in response to a second command which is issued from the host and indicates the security memory device to exit the security field, prohibiting the host from accessing the security region by the memory controller.

### BRIEF DESCRIPTION OF THE DRAWINGS

FIG. 1 shows a functional block diagram of a security memory device according to one embodiment of the application.

FIG. 2 shows a flow of an operation method of a security memory device according to one embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DESCRIPTION OF THE EMBODIMENTS

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

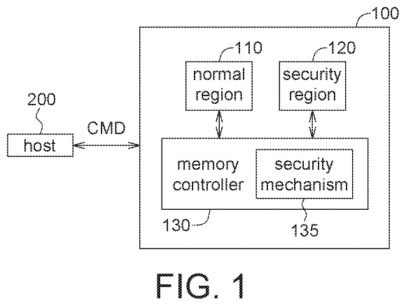

FIG. 1 shows a functional block diagram of a security memory device according to one exemplary embodiment of the application. As shown in FIG. 1, the security memory device 100 according to one exemplary embodiment of the application includes a normal region 110, a security region 120 and a memory controller 130. The memory controller 130 includes a security mechanism 135. A host 200 which is coupled to the security memory device 100 may issue a command CMD to the security memory device 100 for reading data from or writing data into the security memory device 100.

The normal region 110 is used for storing normal data. In the application, “normal data” means data which is not protected by the security function of the security memory device 100. Thus, the normal region 110 may be accessed by the host 200 without passing the authentication by the security mechanism 135.

The security region 120 is used for storing security data. In the application, “security data” means data which is protected by the security function of the security memory device 100. In other words, the security region 120 is accessed by the host 200 only after the host 200 passes the authentication by the security mechanism 135. The size of the normal region 110 and/or the security region 120 may be fixed or adjustable if needed.

The memory controller 130 is coupled to the normal region 110 and to the security region 120. The memory controller 130 is used for controlling operations of the security memory device 100 based on the command CMD from the host 200. The host 200 may issue SPI (Serial Peripheral Interface) flash command set to the security memory device 100 and thus the memory controller 130 controls to execute the SPI read operations and the SPI write operations for reading data from the normal region 110 or writing data into the normal region 110. Further, the host 200 may issue the security command set to the security memory device 100; and the memory controller 130 controls to execute data read from the security region 120 or execute data write into the security region 120 and to execute authentication operations, encryption operations or decryption operations through the security mechanism 135. The security command set includes any combination of a security read command set, a security write command set and a security erase command set.

The security mechanism 135 includes at least one algorithm, for example, at least one authentication algorithm, at least one encryption algorithm and/or at least one decryption algorithm. In details, when the host 200 issues the security read command set to the security memory device 100, the memory controller 130 controls to execute data read from the security region 120 and to execute the encryption operation on data read from the security region 120 through the security mechanism 135. Then, the security memory device 100 provides encrypted data to the host 200.

On the other hand, when the host 200 issues the security write command set to the security memory device 100, the host 200 sends encrypted data to the security memory device 100. Then, the memory controller 130 executes the decryption operation on the encrypted data sent from the host 200 through the security mechanism 135. After the decryption operation, the memory controller 130 writes the decrypted data into the security region 120.

In some exemplary embodiments of the application, the authentication operation may be optional. If the authentication operation is enabled, each time the host 200 tries to read data or write data into the security region 120, the host 200 needs to pass authentication through the security mechanism 135 (i.e. the memory controller 130 checks whether the host 200 passes authentication through the security mechanism 135 or not). If the host 200 successfully passes authentication through the security mechanism 135, the host 200 hence is allowed to read data from the security region 120 or write data into the security region 120. On the contrary, if the host 200 fails to pass authentication through the security mechanism 135, the host 200 is prohibited from reading data from the security region 120 or writing data into the security region 120.

In addition, in response to the security command set from the host 200, the memory controller 130 may perform erase operations on the security region 120.

In some exemplary embodiments of the application, before executing the security command set, the security memory device 100 should enter the security field first. And, after all desired security command sets are completed, the security memory device 100 should exit the security field. Also, if the security memory device 100 is not in the security field, the security memory device 100 ignores the security command set issued from the host 200.

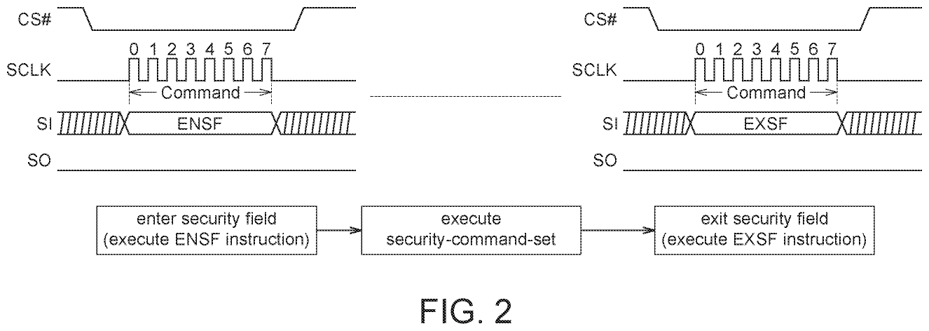

Please refer to FIG. 2 which shows a flow of an operation method of the security memory device 100 according to an exemplary embodiment of the application. FIG. 2 shows that the security memory device 100 enters the security field to use the security command set in the authentication operation, the encryption operation or the decryption operation. After the desired security command sets are completed, the security memory device 100 exits the security field. In FIG. 2, “CS #”, “SCLK”, “SI” and “SO” refer to a chip selection signal, a clock signal, a serial input signal and a serial output signal, respectively.

In order to enter the security field, the host 200 issues the ENSF (enter security field) command to the security memory device 100. In the following descriptions, the ENSF command and the EXSF command are both 8 bits, for example, but the application is not limited by. When the host 200 issues the ENSF command, the SPI waveforms are shown in FIG. 2. The chip selection signal # CS is pulled low, the 8-bit command on the serial input signal SI is received in 8 SCLK cycles while the serial output signal SO is in a high impedance state. After the security memory device 100 receives the 8-bit command, the memory controller 130 determines whether the 8-bit command is the ENSF command or not. If the memory controller 130 determines that the 8-bit command is the ENSF command, the memory controller 130 sets a latch (not shown) or a flag (not shown) to indicate that the security memory device 100 enters the security field (i.e. the host 200 is allowed to access the security region 120).

After the security memory device 100 enters the security field, the host 200 issues the security read command set and/or the security write command set to the memory controller 130 of the security memory device 100 for accessing the security region 120. As described above, in security field, when the host 200 issues the security read command set to the security memory device 100, the memory controller 130 controls to execute data read from the security region 120 and to execute the encryption operation on data read from the security region 120 through the security mechanism 135. The security memory device 100 provides encrypted data to the host 200.

On the other hand, in the security field, when the host 200 issues the security write command set to the security memory device 100, the host 200 sends encrypted data to the security memory device 100. The memory controller 130 executes the decryption operation on the encrypted data sent from the host 200 through the security mechanism 135. After decryption operation, the memory controller 130 writes the decrypted data into the security region 120.

After the host 200 completes the security command sets, the host 200 issues the EXSF (exit security field) command to the security memory device 100 and then the security memory device 100 exits the security field. Similarly, when the host 200 issues the EXSF command, the SPI waveforms are shown in FIG. 2. As shown in FIG. 2, the chip selection signal # CS is pulled low, the 8-bit command on the serial input signal SI is received in 8 SCLK cycles while the serial output signal SO is in a high impedance state. After the security memory device 100 receives the 8-bit command, the memory controller 130 determines whether the 8-bit command is the EXSF command or not. If the memory controller 130 determines that the 8-bit command is the EXSF command, the memory controller 130 resets (or clears) the latch or the flag (not shown) to indicate that the security memory device 100 exits the security field (i.e. the host 200 is prohibited from accessing the security region 120).

In some exemplary embodiments of the application, in order to read data from the security region 120 or write data into the security region 120, the ENSF command is issued from the host 200 to the security memory device 100 and thus the security memory device 100 enters the security field. After access on the security region 120 is completed, the EXSF command is issued from the host 200 to the security memory device 100 and then the security memory device 100 exits the security field. The host 200 is prohibited from accessing the security region 120 after the security memory device 100 exits the security field. Thus, security protection of the security memory device 100 is implemented.

It will be apparent to those skilled in the art that various modifications and variations can be made to the disclosed embodiments. It is intended that the specification and examples be considered as exemplary only, with a true scope of the disclosure being indicated by the following claims and their equivalents.

1. A security memory device coupled to a host, the security memory device comprising:
a normal region for storing normal data;
a security region for storing security data; and
a memory controller, coupled to the normal region and to the security region, wherein
in response to a first command issued from the host indicating the security memory device to enter a security field, the memory controller allows the host to access the security region;
in the security field, the memory controller performs at least one security command set on the security region; and
in the security field, in response to a second command issued from the host indicating the security memory device to exit the security field, the memory controller prohibits the host from accessing the security region.

2. The security memory device according to claim 1, wherein the security region is accessed by the host after the host passes authentication by the memory controller.

3. The security memory device according to claim 1, wherein in response to the at least one security command set from the host, the memory controller controls to execute data read from the security region or data write into the security region and to execute authentication operation, encryption operation or decryption operation.

4. The security memory device according to claim 1, wherein the memory controller includes a security mechanism which includes at least one authentication algorithm, at least one encryption algorithm and/or at least one decryption algorithm.

5. The security memory device according to claim 4, wherein
when the host issues a security read command set to the security memory device, the memory controller controls to execute data read from the security region and to execute an encryption operation on data read from the security region through the security mechanism; and
the security memory device provides encrypted data to the host.

6. The security memory device according to claim 4, wherein
when the host issues a security write command set to the security memory device, the host sends encrypted data to the security memory device;
the memory controller executes a decryption operation on the encrypted data sent from the host through the security mechanism; and
after the decryption operation, the memory controller writes decrypted data into the security region.

7. The security memory device according to claim 4, wherein when the host tries to read data from the security region or write data into the security region, the memory controller checks whether the host passes authentication through the security mechanism or not for determining whether the host is allowed to access the security region or not.

8. The security memory device according to claim 1, wherein in response to the at least one security command set from the host, the memory controller performs erase operations on the security region.

9. The security memory device according to claim 1, wherein the at least one security command set includes any combination of a security read command set, a security write command set and a security erase command set.

10. An operation method for a security memory device coupled to a host, the operation method comprising:
in response to a first command issued from the host indicating the security memory device to enter a security field, allowing the host to access a security region of the security memory device by a memory controller of the security memory device;
in the security field, performing at least one security command set on the security region by the memory controller; and
in the security field, in response to a second command issued from the host indicating the security memory device to exit the security field, prohibiting the host from accessing the security region by the memory controller.

11. The operation method according to claim 10, wherein the security region is accessed by the host after the host passes authentication by the memory controller.

12. The operation method according to claim 10, wherein in response to the at least one security command set from the host, the memory controller controls to execute data read from the security region or data write into the security region and to execute authentication operation, encryption operation or decryption operation.

13. The operation method according to claim 10, wherein the memory controller includes a security mechanism which includes at least one authentication algorithm, at least one encryption algorithm and/or at least one decryption algorithm.

14. The operation method according to claim 13, wherein
when the host issues a security read command set to the security memory device, the memory controller controls to execute data read from the security region and to execute an encryption operation on data read from the security region through the security mechanism; and
the security memory device provides encrypted data to the host.

15. The operation method according to claim 13, wherein
when the host issues a security write command set to the security memory device, the host sends encrypted data to the security memory device;
the memory controller executes a decryption operation on the encrypted data sent from the host through the security mechanism; and
after the decryption operation, the memory controller writes decrypted data into the security region.

16. The operation method according to claim 13, wherein when the host tries to read data from the security region or write data into the security region, the memory controller checks whether the host passes authentication through the security mechanism or not for determining whether the host is allowed to access the security region or not.

17. The operation method according to claim 10, wherein in response to the at least one security command set from the host, the memory controller performs erase operations on the security region.

18. The operation method according to claim 10, wherein the at least one security command set includes any combination of a security read command set, a security write command set and a security erase command set.
